(19) United States
(12) Patent Application Publication
(10) Pub. No.: US 2007/0185820 A1
(43) Pub. Date: Aug. 9, 2007

(54) Multi-account security verification system with a virtual account and linked multiple real accounts

(76) Inventor: Albert I. Talker, Marlboro, NJ (US)

Correspondence Address: Albert I. Talker, 17 Memorial Rd, Marlboro, NJ, 07746, US

(21) Appl. No.: 11/349,655

(22) Filed: Feb. 8, 2006

(51) Int. Cl. G06Q 99/00

(52) U.S. Cl. 705/67

(57) ABSTRACT

A multi account security verification system, which consists off a virtual account card and a central authentication enterprise. The cardholder is able to select one of the real accounts belonging to the account owner by adding control digits to the virtual account number. The real account is retrieved from the Central Authentication Enterprise by accessing the virtual account number record stored in a system database thereby retrieving the selected real account number associated with the control digits and the virtual account number. The database may also store a plurality of secret keys or public/private key sets associated with the virtual account number in addition to optional BIO information, which can be used for authentication and authorization

### FIELD OF THE INVENTION

This invention relates to multi-account security verification system for conducting business transactions and for account verifications. Specifically this invention relates to a transaction system, which enables a single card to be used as a substitute for a plurality of conventional credit cards, identification cards, membership cards, benefit cards and other objects, which include indicia such as magnetic indicia or bar code. Multi account authentication and authorization is achieved by comparing entered data against one or more PINs/Keys stored within a system database.

### BACKGROUND OF THE INVENTION

The most common types of credit and debit cards in use today are magnetic stripe type cards. The standardized format used for such cards includes indicia on a front side of the card. Such indicia identifies the card owner, an account number, a card type, a card issuer, an expiration date as well as possibly other information. Such indicia is presented as raised letters and numbers which can be used to make an impression on a multipart carbon or carbonless form. The rears of such cards have a magnetic stripe supported thereon. The magnetic stripe includes several tracks of information. This information includes magnetic indicia representative of the information found on the front of the card as well as other information that is used in processing transactions electronically. Magnetic stripe cards are commonly used for credit card types such as MasterCard.RTM., VISA.RTM., Discover.RTM., American Express.RTM., Diner's Club.RTM. and others.

Most people also carry debit cards, which allow them to access money in their checking, and savings accounts using automated banking machines. Some debit cards also function as credit cards. Most debit cards in use today are magnetic stripe cards similar in format to credit cards.

Due to the convenience of using credit and debit cards most people carry several such cards in their wallet. Because of financial incentives associated with the issuance and sponsorship of credit cards, many users are offered cards by different banks, clubs, fraternal organizations and merchandising organizations. As a result it is not uncommon for people to have several different MasterCard.RTM. and VISA.RTM. accounts. This gives consumers the opportunity to take advantage of premiums such as frequent flyer miles and rebates offered by card sponsors. Having several different credit cards also enables consumers to take advantage of the credit limits on all their cards. While having many credit and debit cards is a benefit to consumers, it also requires them to carry several cards. It also exposes consumers to a greater risk if their wallet or purse that includes all their credit and debit cards is lost or stolen.

Most individuals also carry a number of other objects or cards, which include machine-readable indicia. These often include for example, a health insurance card, which indicates that a person is a member of a particular group insurance plan. Such cards are often magnetic stripe cards similar to credit cards. Alternatively such health insurance cards may include bar code indicia or other visible indicia, which can be read with a scanner. Some health insurance cards include both visible and magnetic indicia. Persons who are members of a health insurance plan can identify themselves and their account to medical providers by showing their card, which can be read or scanned by appropriate devices.

Persons also commonly carry other types of cards with visible or magnetic indicia. These may include for example, library cards, identification or access cards, employee identification cards, student identification cards, driver's license cards, professional license cards and other types of card like objects. The magnetic or visible indicia on these cards are usually read when presented by the cardholder to identify the person as an authorized user of services or facilities.

Another type of card, which has been developed, is the stored value card commonly referred to as a “smart card”. Stored value cards are similar to credit and debit cards in construction in that they include a front side which has raised identifying indicia which can be transferred to a carbon or carbonless multipart form. Such cards also commonly include a magnetic stripe including magnetic indicia, which enables the card to work like any other credit or debit card. Stored value cards also include a programmable memory mounted on the card. Such programmable memory stores data representative of cash value. The value on the stored value card can be used like cash by the bearer to purchase goods or services. The stored value data on the card is also often encrypted or stored using schemes to prevent fraud or tampering therewith.

Stored value cards, like debit and credit cards, require the customer to interact with a stationary terminal device to utilize the card. For example, in the case of credit cards, credit is obtained when the customer presents their card to a merchant. The merchant (unless they process transactions manually) utilizes a point of sale or electronic funds transfer terminal to charge an amount to the customer's account and credit the merchant's account. Similarly the use of a debit card requires that the user present their card to an automated banking machine such as an ATM. The ATM operates to add or deduct amounts from the user's account as funds are deposited or received by the user. Similarly, stored value cards are used in connection with a stationary terminal device such as an electronic funds transfer terminal or automated banking machine which has the special capabilities to handle the particular type of stored value card used. The terminal modifies the value information stored in memory on the card to reflect the addition or subtraction of value represented thereon as transactions are conducted.

Having to use a stationary terminal device to conduct transactions is often inconvenient. Most merchants only accept certain types of credit cards. Locating an ATM that accepts the debit card of a person's financial institution can be difficult. Often the use of a “foreign” card at another bank's ATM results in a significant service charge. It is also difficult to find a merchant or ATM that can process stored value cards.

Thus there exists a need for a system and a method that can reduce the number of credit, debit and other cards or card like objects that a person must carry while still obtaining the benefit of carrying all such cards and objects individually.

There further exists a need for an apparatus and method, which gives a single card the ability to be used as a substitute for any one of a plurality of credit, debit or other cards.

Finally there further exists a need for an apparatus and method for carrying out transactions with added security features for authentication and authorization.

The many attempts at providing a smart, secure credit card system in the past have proven too user unfriendly or unreliable, and this is believed why such cards have not gained user acceptance.

Unlike the prior art, the present invention provides an easily implemented security system with multiple accounts, which utilizes some of the features of the standard credit card, but without the necessity of the user having to be computer literate, or knowing how to type, etc.

A listing of patents which are believed to have some pertinence to the present invention follow:

| Patent Number | Inventor | Date of Issue |
|---|---|---|
| 6,954,740 | Talker | Oct. 11, 2005 |
| 5,326,964 | | |
| 5,317,636 | | 1994 |
| 5,276,311 | Hennige | Jan. 04, 1994 |
| 5,255,941 | Solomon | Oct. 26, 1993 |
| 4,947,027 | Kashkashian, Jr | Oct. 13, 1987 |
| 4,707,594 | Roth | Nov. 17, 1987 |
| 4,697,073 | Hara | Sep. 29, 1987 |
| 4,587,413 | Hoppe et al | May 06, 1986 |
| 3,902,262 | Colegrove et al | Sep. 02, 1975 |
| 3,833,929 | Kirley | Sep. 03, 1974 |

U.S. Pat. No. 6,954,740 issued in 2005 teaches an “Action verification system using central verification authority” which does not include a multi account card. This current invention disclosure teaches of a “Multi Account Card” which can be cross-referenced to U.S. Pat. No. 6,954,740, which was patented by the same inventor.

U.S. Pat. No. 5,255,941 issued in 1993 teaches an “Antifraud Credit Card Assembly” teaching a card, which includes a slidingly removable magnetic strip, to prevent unauthorized use of said card. Without the magnetic strip, the card is recognized as unusable. The present invention made subject this application differs in both method and apparatus for accomplishing the security verification, and card structure.

U.S. Pat. No. 5,326,964, apparently teaches a “Separable multi-account safety credit card system”, wherein the account numbers and the card are “mechanically detachable into two component parts, whereby that part upon which is embossed the credit account numbers may be separately carried from the individual identification part. . . ” to prevent unauthorized transactions. The present invention made subject this application differs in both method and apparatus for accomplishing the security verification, and card structure.

U.S. Pat. Nos. 5,317,636 and 5,276,311 teach smart credit cards having a QUERTY keypad or the like thereon for entry of passwords, and displays for indicating account information, signature information, or the like.

U.S. Pat. Nos. 4,697,073 teaches a credit card which appears to have separable the electronics, along with contact means for communicating with the verifying equipment.

The remaining patents cited are included for general information and research purposes, teaching various credit card systems, but do not appear to be as pertinent as the above-cited patents.

### GENERAL SUMMARY DISCUSSION OF THE INVENTION

Unlike the prior art, the present invention contemplates a multi account card security system which is flexible in its various alternative uses, effective in promoting security, easy to use, and relatively inexpensive to produce and maintain.

The above patents may contemplate various alternative card systems, some programmable, some having removable indicia (magnetic or raised), but none contemplate the present system wherein the card has a virtual account number and which real account is retrieved from a Central Authentication Enterprise.

The preferred embodiment of the present invention teaches a card body having the same basic dimensions and the same physical appearance of a standard credit card. In contrast to other cards, the card of the present invention does not include any real account, and the real accounts are linked to the card are stored in a database accessed by the Central Authentication Enterprise.

As will be set forth below, an alternative embodiment of the present invention is also contemplated which utilizes a smart card which includes the virtual account and set of PINs stored in its memory.

As will be set forth below, an alternative embodiment of the present invention is also contemplated which utilizes a smart card which includes the virtual account and BIO data transmission mechanism.

As will be set forth below, an alternative embodiment of the present invention is also contemplated which utilizes a smart card which includes the virtual account, PINs and BIO data stored in storage means and data transmission mechanism used to transmit/receive the stored data.

It is thus an object of the present invention to provide a multi account security verification system which is inexpensive to manufacture, and easy to operate.

It is another object of the present invention to provide a secure multi account card system, which effectively prevents unauthorized access to valuable account data.

It is another object of the present invention to provide a secure multi account card system comprising display means, which lists accounts by name on the card's body.

It is another object of the present invention to provide a method for preventing card theft, utilizing a virtual account number for accessing multiple real account numbers stored on a central database, and means for entering key/pin used to select the needed account which could be further used for authentication and authorization.

It is another object of the present invention to provide a method for preventing card theft, utilizing a virtual account number for accessing multiple real account numbers stored on a central database, and means for capturing and transmitting BIO data which could be further used for authentication and authorization.

It is another object of the present invention to allow the use of a PIN/KEY, which can be used to validate an Entity's identity and its authorization through the use of a PIN/KEY code entered into a data entry unit.

It is therefore a further object of this invention that the remote Central Authentication Enterprise can communicate safely with another system by means of ordinary non-protected communication lines.

It is therefore a further object of this invention that the system has sufficient mobile capabilities so as to allow an Entity to authorize a transaction and enter a transaction PIN/KEY at various locations and through electronic.

For the foregoing reasons, there is a need for an easily implemented security system with a single virtual account card that can process multiple accounts, which utilizes some of the features of the standard card, but without the necessity of the entity having to be computer literate, while preventing unauthorized transactions. It is to such a system that the present invention is directed.

### BRIEF DESCRIPTION OF THE DRAWINGS

FIG. 1 is a schematic, diagrammatic view of a multi-account security verification system operating in accordance with the present invention, showing the card, the database and the Central Authentication Enterprise.

FIG. 2 is a schematic, diagrammatic view of a multi-account security verification system operating in accordance with the present invention, showing the card, the database, the Central Authentication Enterprise, the merchant and the Financial Enterprise/Clearing Agent.

FIG. 3 is a schematic, diagrammatic view of a multi-account security verification system operating in accordance with the present invention, showing a smart card with PIN/Key list stored in its memory, the database, the Central Authentication Enterprise, the merchant and the Financial Enterprise/Clearing Agent.

FIG. 4 is a schematic, diagrammatic view of data input devices used to input data into the multi-account security verification system. In addition, a schematic view is depicted to show card input entered by an entity using the input devices listed.

FIG. 5 is a schematic, diagrammatic view of another embodiment of a multi-account security verification system operating in accordance with the present invention, showing a smart card with PIN/Key list stored in its memory, optional terminal links and a BIO identification unit embedded in the card.

FIG. 6 is a schematic, diagrammatic view of another embodiment of a multi-account security verification system operating in accordance with the present invention, showing a smart card with PIN/Key selection control and which also include optional terminal links and optional BIO identification unit embedded in the card.

FIG. 7 is a schematic, diagrammatic view of another embodiment of a multi-account security verification system operating in accordance with the present invention, showing a CAE and Merchant functionality merged into one functional block.

FIG. 8 is a schematic, diagrammatic view of another embodiment of a multi-account security verification system operating in accordance with the present invention, showing a CAE and Financial Enterprise/Clearing Agent functionality merged into one functional block.

FIG. 9 is a schematic, diagrammatic view of another embodiment of a multi-account security verification system operating in accordance with the present invention, showing a smart card with PIN/Key selection control and which also include optional terminal links and optional BIO identification unit embedded as one integrated unit, which in this invention can be a personal computer or any other computing device.

For a further understanding of the nature and objects of the present invention, reference should be had to the following detailed description, taken in conjunction with the accompanying drawings, in which like parts are given like reference numerals.

### DETAILED DESCRIPTION OF THE INVENTION

Definitions of Terms

Merchant (6)—The term “Merchant” as used herein means an individual, company, vendor or other Entity trying to verify a transaction and account#.

Security Verification-The term “Security Verification” as used herein means validation of Entity's identity, account number verification, and authorization of an transaction.

Entity (2)—The term “Entity” as used herein means an individual, company, vendor or other organization which authorizes by giving a virtual account number and a PIN/KEY, the execution, processing or delivering of an action.

Transaction—The term “transaction” as used herein means a transaction authorized by an Entity, which can be requested and/or transmitted and/or delivered and/or executed electronically or mechanically. Wherein transaction includes a financial transaction, message, command, non-financial transaction, approval, identification request, real account request, and data approval.

Central Authentication Enterprise (5)—The term “Central Authentication Enterprise” or “CAE” as used herein means an individual, company, organization or other Entity which can embed and communicate with systems which embed the information and/or processes requiring security verification together with the procedural capability to perform such security verification. It should be noted that in this document the security verification can be performed by the Central Authentication Enterprise by using data stored in a central database.

Computer System AND Computer AND Programmed Logic Systems—The term “Computer System” and “Computer” and “Programmed Logic Systems” as used herein means a system or systems, which are able to embody and/or execute the logic of the processes, described herein. The logic embodied in the form of software instructions or firmware may be executed on any appropriate hardware which may be a dedicated system or systems, or a general purpose computer system, or distributed processing system, all of which are well understood in the art, and a detailed description of how to make or use such computers is not deemed necessary herein. It should be noted that the Central Authentication Enterprise computer, and database as described herein may be embedded within a single computer or programmed logic system, or be implemented as separate computers or programmed logic systems, or be executed on multiple systems using any of the distributed processing models as are well understood in the art, or be implemented using any mixture of the above.

Financial Enterprise/Clearing Agent (8)—The term “Financial Enterprise/Clearing Agent” as used herein means an company, organization or other Entity which can embed and communicate with systems which embed the information and/or processes requiring security verification of real account data together with the procedural capability to perform such security verification and transaction authorization of transactions linked to real accounts belonging to an entity.

Real Account—The term “Real Account” as used herein means a conventional credit/debit card accounts, checking accounts, financial accounts, identification card accounts, membership card account, benefit cards accounts and other objects which include account number.

Virtual Account—The term “Virtual Account” as used herein means an account number that may include any combination of alphanumeric digits, which is used to link a set of Real Accounts.

Financial Enterprise/Clearing Agent (8)—The term “Financial Enterprise/Clearing Agent” as used herein means an company, organization or other Entity which can embed and communicate with systems which embed the information and/or processes requiring security verification of real account data together with the procedural capability to perform such security verification and transaction authorization of transactions linked to real accounts belonging to an entity.

Communication Link/Computer Network (32)—The term “communication link” interchangeably referred also as “Computer Network” refer to any suitable communication link, which permit communications (e.g. Internet, computer network, telephone). It should be understood that the term “communication link” is not limited to “Internet” or any other particular system or type of communication link. That is, the term “communication link” is intended only to refer to any suitable communication system, including extra-computer system and intra-computer system communications. Examples of such communications systems include internal busses, local area networks, wide area networks, point-to-point shared and dedicated communications, infra-red links, microwave links, telephone links, CATV links, Satellite and radio links and fiber-optic links. The term “communication link” can also refer to any suitable communication system for sending messages between remote locations, directly or via a third party communication provider such as AT&T. In this instance, messages can be communicated via telephone or facsimile or computer synthesized voice telephone messages with or without voice or tone recognition, or any other suitable communications technique.

It should be understood that each of the communication links are shown and described separately herein for the sole purpose of clearly illustrating the information being communicated between the Central Authentication Enterprise, the Merchant and the Entity. In operation, the communication links may not be separate communication links but may be a single communication link.

“PIN”—The term “PIN” or “Pin” or KEY or PIN/KEY refer to Personal Identification Numbers, Key Codes, public/private keys or Tokens. Each Entity will have sets of individualized PINs/Keys linked to his virtual account which one of them may be uniquely associated with, or identify a particular transaction, activity or other item that needs security verification. The PINs/Keys may be stored with it virtual account number suitable for identifying a particular transaction. These PINs/Keys may be generated using a predetermined strategy or arbitrary generated by a computer. The PINs/KEYs may include a predetermined strategy formula to generate further sets of PINs/KEYs that can be used to verify future transactions. The Entity can only perform the selection of the appropriate formula. PINs/KEYs can also be supplied to the Entity by a form of printed list or labels, or by using electronic means wherein the Entity may able to select a PIN/KEY and supply the PIN/KEY to the merchant.

BIO data—The term “BIO” as used herein means any personal BIO data or BIO identification confirmation data including finger prints, retinal scan, face recognition, voice identification, and other personal identification features.

“Control Digits”—The term “Control Digits” refer to Personal Identification Numbers, Key Codes, public/private keys or Tokens used to distinguish and select real account numbers stored in a database linked with the virtual account. “Control Digits” are generally part of the “PIN” or can be interchanged with the “PIN” in its entirety.

“Data Input”—The term “Data Input” refer to PIN (defined above), Control Digits (defined above), and BIO (defined above) data entry

The Security Verification/Response transmission process can be done by means of a transformation, mapping or encryption process.

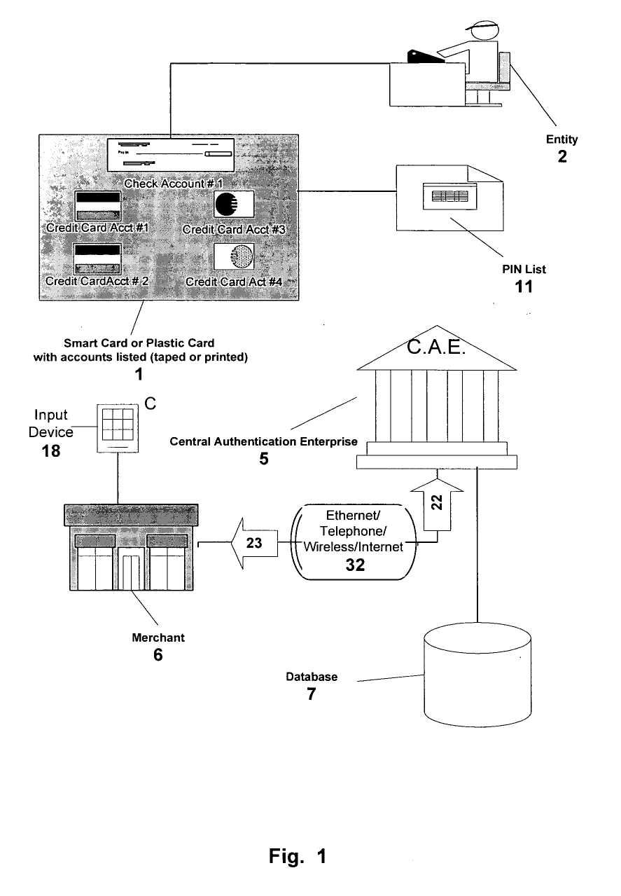

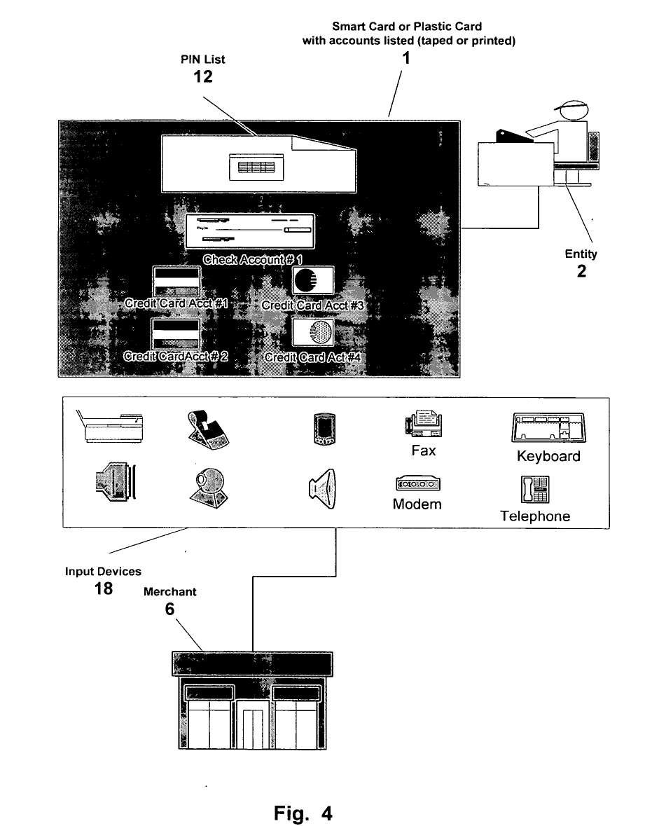

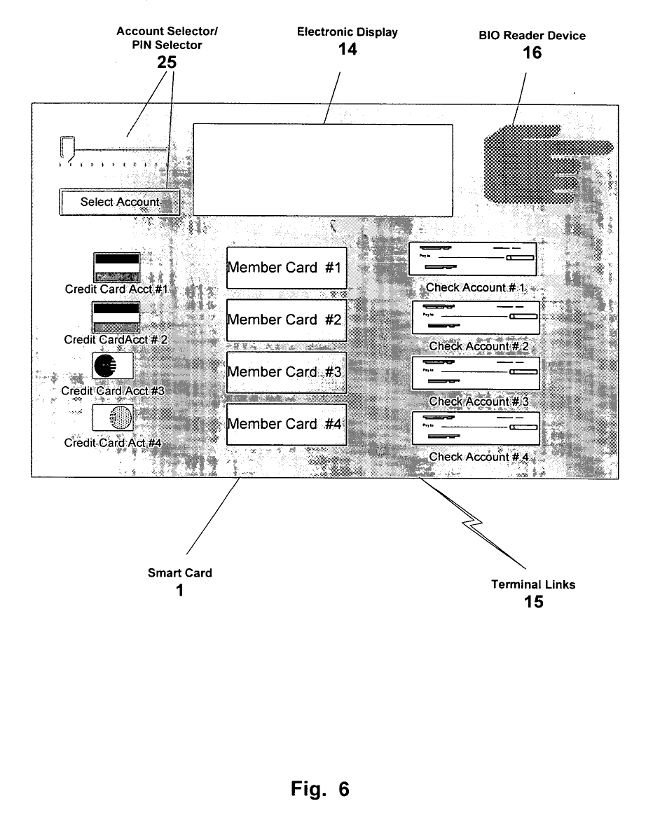

### Description of Components—(Referring to FIG. 1, FIG. 4 AND FIG. 6.)

Multi account Card 1—Plastic Conventional Card

The multi-account card 1 may have the dimensional configuration of conventional credit and debit cards. It can include a magnetic stripe or bar-code print on a rear face thereof. The magnetic stripe is capable of holding magnetic indicia similar to the magnetic stripes on conventional debit, credit and similar cards. The bar-code print is capable of holding account data similar to the data held in magnetic stripes on conventional debit, credit and similar cards.

As later explained, multi-account card 1 is designed to be used as a substitute for a plurality of varied types of credit, debit and other cards. However, in embodiments of the invention, card 1 may include information on the face or rear thereof so as to identify the particular user to whom the card belongs, an issuer of the card, as well as other data. In some embodiments, the front side of the card may include raised numbers and letters corresponding to a particular virtual account and from which an impression may be made onto a carbon or carbonless form. In some embodiments, the front side of the card may include printed, glue labeled, or embossed (raised) captions including numbers and letters, corresponding to real accounts titles/names linked to the particular virtual account.

For example, information on the face of the card may correspond to a user's MasterCard.RTM., VISA.RTM., American Express.RTM., Discovery.RTM., checking accounts ,investment accounts, or other accounts. This enables the exemplary card to be used as the user's regular credit card when purchasing goods or services in establishments that do manual processing of credit card transactions. Of course while in the embodiment discussed, conventional credit card indicia may be included on the front of the card, in other embodiments special indicia may be presented on the card.

Multi-Account Card 1—Smart Electronic Card

The multi-account card 1 may have the dimensional configuration of conventional credit and debit cards. As later explained, multi-account card 1 is designed to be used as a substitute for a plurality of varied types of credit, debit and other cards. However, in embodiments of the invention, card 1 may include information on the face or rear thereof so as to identify the particular user to whom the card belongs, an issuer of the card, as well as other data. In some embodiments, the front side of the card may include raised numbers and letters corresponding to a particular virtual account and from which an impression may be made onto a carbon or carbonless form. In some embodiments, the front side of the card may include printed, glue labeled, or embossed (raised) captions including numbers and letters, corresponding to real accounts titles/names linked to the particular virtual account. For example, information on the face of the card may correspond to a user's MasterCard.RTM., VISA.RTM., American Express.RTM., Discovery.RTM., checking accounts ,investrnent accounts, or other accounts. This enables the exemplary card to be used as the user's regular credit card when purchasing goods or services in establishments that do manual processing of credit card transactions.

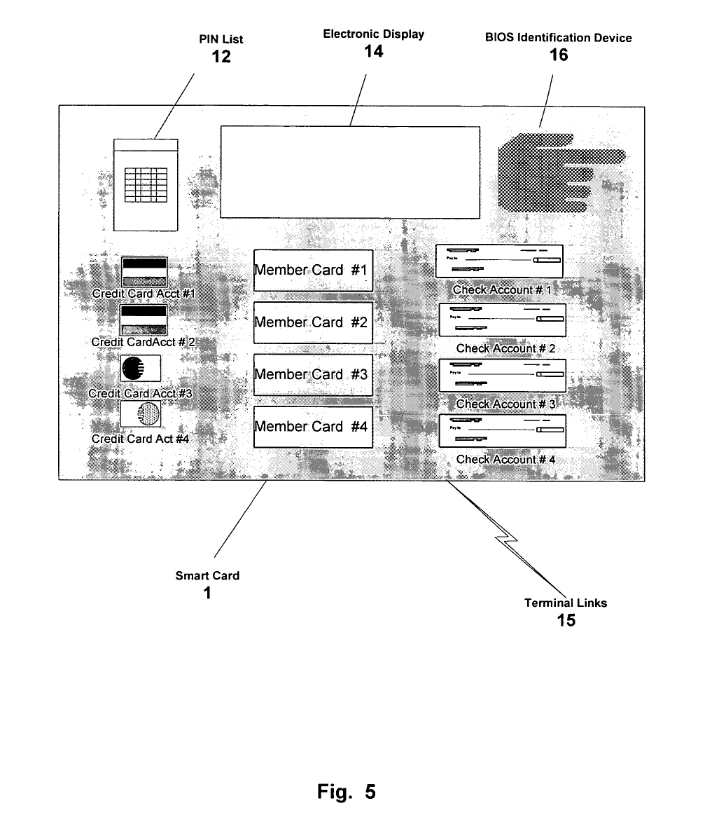

As shown in FIG. 5 and 6 the card further includes terminal links 15 which are used to communicate data with the smart card memory. In the embodiment shown, the memory reading and writing functions are combined schematically and are schematically shown using terminal links 15. However, it should be understood that these are separate functions and may be carried out through separate arrangements of hardware and software. The card 1 further includes the hardware and software devices required to read data from and write data into the card's memory using terminal links 15. The memory data includes the virtual account data linked account names, and PINS/KEYs list 12 linked to the accounts.

As shown in FIG. 6 in the embodiment shown, the card may further include an input device, which includes a manual input device for selecting Account/PIN. The Account/PIN selector 25 can be used for entry or selection of the user's PIN or Control Digits stored as PINS/KEYs list 12 (FIG. 5). The card also includes an electronic display screen 14 on the front face thereof. In one exemplary form of the invention electronic display screen 14 is an LCD type display or other suitable display that may be used for displaying words, graphics and other visible indicia in a manner later explained. When pressing the button or slider 25, the electronic display screen 14 begins a scrolling through the listed accounts in memory. The card then will display the required PIN in the display screen 14 used to select the corresponding account and further can be used for authentication. The card may include only buttons to scroll up/down (button or slider 25). These scroll up and scroll down buttons, are pressed by a user to selectively display items on the display. The card can be used to transmit the required PIN and virtual account to the Central Authentication Enterprise 5 using terminal means 15.

The card's memory may further include data representative of visual indicia, which are found on a plurality of cards or other objects associated with the virtual account. The visible indicia may include for example, bar code indicia representative of a user's real account. Alternatively such visible indicia may include bar code, alpha numeric accounts or other indicia associated with a membership I.D., Credit Cards, Checking Accounts, student.I.D., employee access card, driver's license, or other types of objects. The visible indicia displayed using display screen 14 may also include a Central Authentication Enterprise 5 responses, real account data, or other data. The terminal means 15 may include options upon which the stored visible indicia may be reproduced in response to inputs to the terminal means. This enables visible indicia displayed in display screen 14 to be read, which serves as a substitute for scanning off the card. The card memory may also include data representative of icons or other graphics as well as data representative of real accounts stored in the CAE 5

Alternative embodiments of the invention may include a bio reader device 16. The bio reader device may include hardware and software components that can be used to sense a characteristic of a user, which uniquely identifies the person as an authorized user. In some embodiments the biometric reader device 16 may include a fingerprint reading device. Alternatively, the reader may include an audio input device, which can be used to identify a user by voice. Alternatively, visual readers for identifying unique visible features or a combination of identifying features of the user may be used. The memory of the card may include data representative of the identifying biometric features of the authorized user or users. This stored data is used to enable authorized users of the card to operate the card while others are prevented from such operation. In addition, terminal means 15 can be used to send bio data to the Central Authentication Enterprise for further authentication.

For example, if the biometric reader is a fingerprint reader, the user may be prompted to bring a finger that they have pre-selected adjacent to the reader. The bio reader 16 would read the fingerprint and produce suitable signals to compare the input data to the data stored on the card. If the input data corresponds to an authorized user, the user is authorized to further operate the card. Altematively in another embodiment, the bio data will be sent to the Central Authentication Enterprise and then compared to BIO data stored in its database, which can be used for further authentication

Terminal means 15 many include wireless means so data can be transmitted from the entity's hand-held card to a merchant terminal. The merchant's terminal, which can be comprised off a computer and communication devices, will communicate with the Central Authentication Enterprise. The merchant's terminal can have built in identification which will further be used Central Authentication Enterprise to identify incoming verification requests. This identification data may be sent along with the account, PIN and bio data from the merchant's terminal to the Central Authentication Enterprise.

The card 1 can also have security measures to prevent unauthorized access for usage of the card. For example, a card user may be required to provide at least one identifying input prior to being permitted to use the card. This may include the card user providing a biometric input, such as a fingerprint, to the card, or input a pass code before using the card. Alternatively, the card can wirelessly transmit captured BIO data to the CAE for external authorization.

The Card 1 and its attached peripherals is reflected as a separate functional block, it should be understood that the card may be implemented in such a fashion that part or all of its logic can be embedded within either the Merchant 's 6 computer or the Entity's 2 computer.

Data Input Devices

The input device 18 can include any one or more of the following:

1. Portable terminal.

2. Keyboard

3. Keypad

4. Modem

5. Computer

6. Laptop

7. PDA

8. Voice Recognition mechanism

9. Cam Camera

10. Bar Code Reader

11. Magnetic stripe reader

12. Scanner

13. Digital Input

The input device is preferably sufficiently small so as to be readily portable. The input device 18 operates in conjunction with the card or alternatively can be built in the card. The input device 18 can include a reading device, which is operative to read the data from the memory on the card. The input device 18 also includes input means, which enables the entity to select account name from the card memory corresponding to any one of the plurality of the entity's accounts. In some embodiments the input device 18 may further include object-reading devices such as a magnetic stripe reader and a bar code scanner. Such input devices are used to read magnetic indicia or bar code from the card, and then accept further data input from the entity using for example, a keypad, and then to transfer such information to the CAE 5.

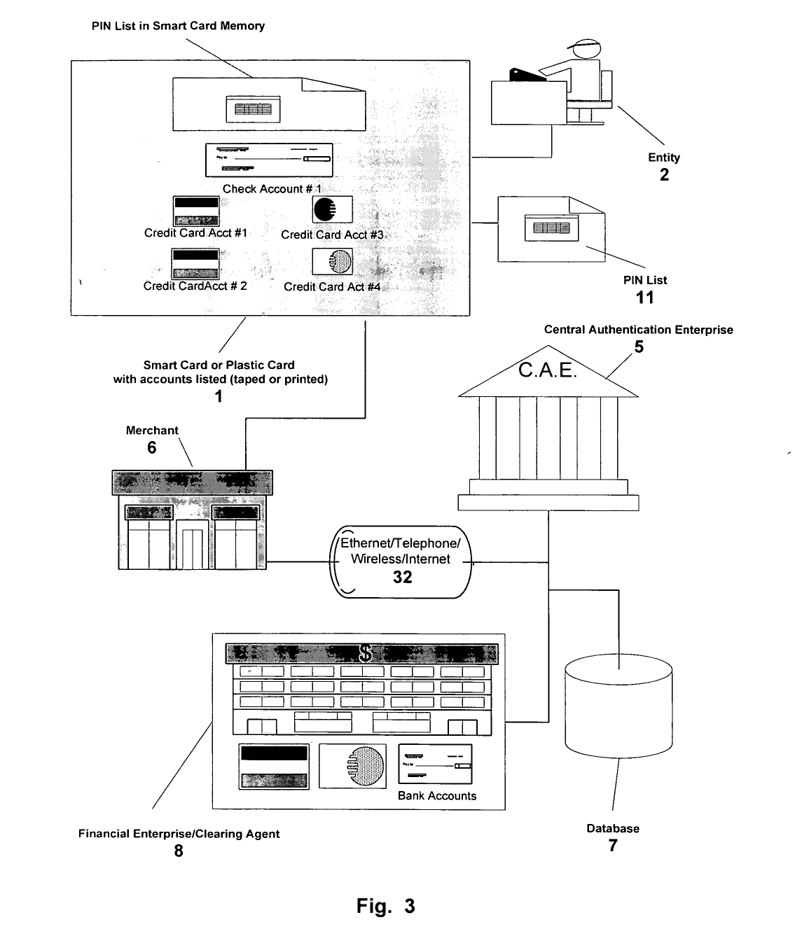

### Description of Process—(Referring to FIG. 1-6)

Process Overview—Preferred Embodiment

Shown in FIG. 1 is a Multi Account Security Verification System for executing verifications of transaction. Each merchant 6 posses an optional input device 18, used as a data entry device. Each Entity 2 posses a card 1 with a virtual account number printed or embedded in the card. The card may be constructed as any other conventional plastic card with a magnetic strip or a bar code. The magnetic strip or the bar code contains the virtual account number assigned to the card. In another embodiment of the card, the card may be constructed as a smart card/RFID card. In this embodiment the card stores the virtual account number and other data in its storage means (memory). When an entity 2 needs to perform a transaction, he submits his card 1 to the merchant 6. The merchant 6 then types-in the input devices 18, control digits as submitted by the Entity 2 as required to retrieve account data. In alternative embodiment, the entity 2 types directly in the input devices 18, the control digits required to retrieve account data. The merchant 6 then submits a verification request to the CAE 5. The CAE process the verification request 22 and returns a verification response 23. The verification response 23 is to be used by the merchant 6 in order to complete the transaction or cancel it.

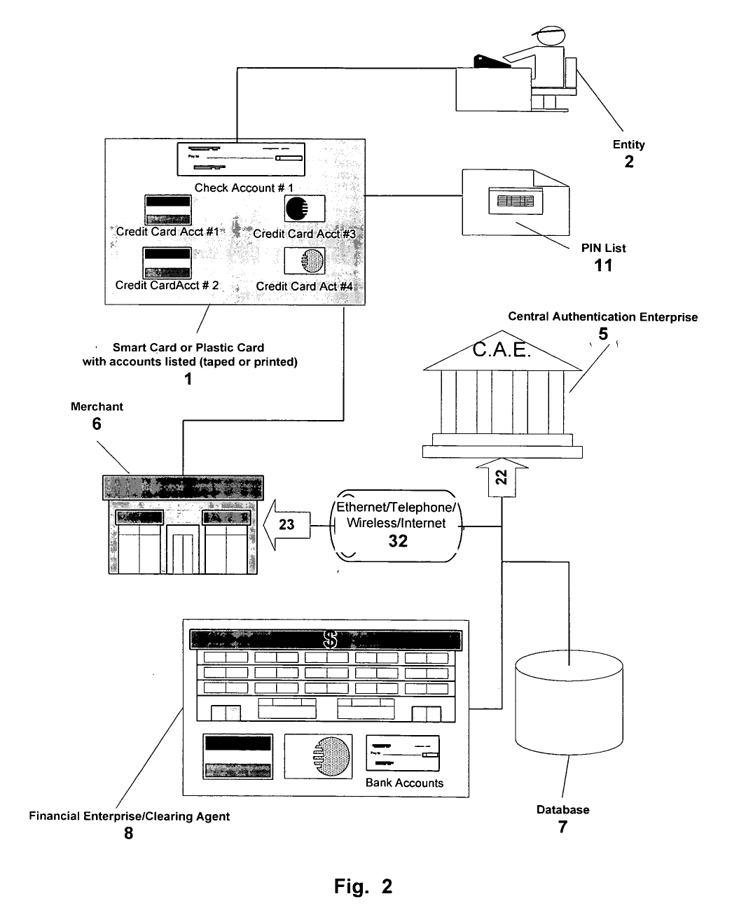

FIG. 2 is a modified version of FIG. 1 and in FIG. 2 the Financial Enterprise/Clearing Agent 8 is added for purposes of clarity of a complete transaction process. The CAE 5 may submit an authorization request to the Financial Enterprise/Clearing Agent 8 in order to further authenticate and authorize the transaction originated by the entity and which the real account was retrieved from the CAE database 7. In a particular example, the Financial Enterprise/Clearing Agent 8 will validate the real account and designate the source of the funds and then it will submit a response to the CAE if funds are available and if the account is valid and authenticated.

In the following description, it should be noted that communication between the Entities, Central Authentication and Merchants involved in a particular verification or transaction may be triggered automatically, for example, by means of a sequential logic process, or through a time schedule system, or alternatively may require a manual intervention to trigger the next phase of an action.

The Central Authentication 5 and its computer is reflected as a separate functional block, it should be understood that the computer may be implemented in such a fashion that part or all of its logic can be embedded within either the Merchant's 6 computer or the Entity's 2 computer.

The Card 1 and its components is reflected as a separate functional block, it should be understood that the card may be implemented in such a fashion that part or all of its logic can be embedded within either the Merchant's 6 computer or the Entity's 2 computer.

Transaction Verification Request

When the Merchant 6 desires to execute a predetermined or particular transaction, originated by an identified Entity 2, they would input a transaction verification request. The transaction verification request can be inputted using any one or more suitable input device 18 (FIG. 4) which can be any input device capable of inputting information such as a keyboard, a scanner, a key pad, a mouse, a modem, a telephone, a network adapter, a voice input device, a camera, a smart card, a remote computer or the like. The transaction verification request then will be transmitted to the Central Authentication 5 via communication link 32. In response to receiving the transaction verification request 22, the Central Authentication Enterprise 5 computer, stores the contents of the request for processing and record-keeping and later additional verification by the Entity 2.

The transaction verification request 22 transmitted between the Merchant 6 and the Central Authentication Enterprise 5 typically contains the following information:
1. Transaction type
2. Merchant's reference
3. Entity's virtual account number and PIN (or Control Digits)
4. Optional data including Entity's name, social security number or other personal identification data
5. Bio data or Bio identification confirmation
6. Optional Merchant's identification code/key
7. Optional data attachments e.g. item/service description
8. Optional transaction quantity

The Central Authentication Enterprise 5 stores the request and then processes the request. It compares the PIN/KEY, virtual account number and other personal data submitted in the verification request with the data stored in the Central Authentication Enterprise. Only when there is a match between the stored data and the parameters sent in the verification request, the request is considered verified. Then the Central Authentication Enterprise 5 formulates a verification response 23. This response is transmitted by the Central Authentication Enterprise 5 to the Merchant 6 via communication link 32. The verification response 23 typically contains the following information:
1. Transaction type
2. Real Account Number
3. Entity's authorization code and reference
4. Verification response
5. Central Authentication Enterprise transaction reference
6. Financial Enterprise/Clearing Agent authorization reference
7. Optional personal data parameters

In response to the receipt of the request, the Central Authentication Enterprise may perform a number of internal and external validity checks before sending a Verification Response.

For example, internal and external validity that the action is valid and funds for the transaction are available. The Central Authentication Enterprise 5 may request further authorizations from other Financial Enterprise/Clearing Agent 8 by submitting a request using communication link 32. In case of bank checks or credit cards, authorization from the issuing bank for a transaction referenced in a Verification Request. After determining the validity of the transaction, the Central Authentication Enterprise 5, can send a response that may take the form of the Verification Response 23.

It should be noted that the data stored in the Central Authentication Enterprise 5 could be accessed, reviewed and acknowledged by the Entity 2. The Entities will have sets of individualized PINs (key codes or tokens) which one of them may be uniquely associated with, or identify a particular transaction. The PINs/KEYs may take the form of password sets, numeric combination, numeric sequence or formula. The PINs/KEYs are entered or selected by Entities using communication link 32 and by using a PIN/KEY entry means 18. The PINs/KEYs may be stored with its referenced virtual account number and optionally linked to specific real account number, which can be used for identifying a particular transaction. These PINs/KEYs could also be generated using a predetermined strategy or arbitrary generated by a computer. The PINs/KEYs may include also a predetermined strategy formula to generate further sets of PINs/KEYS that can be used to verify future transactions. Multiple predetermined strategy formulas can be selected from a library stored in the Central Authentication Enterprise 5. The Entity 2 can only perform the selection of the appropriate formula stored within the Central Authentication Enterprise by using the PIN/KEY entry means 18.

The PINs/KEYs are entered into and stored within the Central Authentication Enterprise 5 using PIN/KEY entry means 18, which can be any suitable manner known in the art, digital signature technology, unique customer coded hardware or software, the use of public/private key encryption techniques or any other suitable form to assure that the keys are selected by the Entity only. The PINs/KEYs can also be generated automatically by the Central Authorization Enterprise and then viewed and approved by the Entity. The Central Authentication Enterprise 5 will typically store the PINs/KEYs for a predetermined period of time controlled either by the Entity or the Verification Authority. In addition to PINs/KEYs, other personal data can be stored and used for verification. For example, BIO data, name, social security number, address, date of birth or other personal data elements can be used together with PINs/KEYs to verify the transaction.

Faulty Verification Request

The Central Authentication Enterprise 5 may issue a Faulty Verification Response to the Merchant 6 via communication links 32, and then retrieve information pertaining to incomplete or faulty verification actions, in order to build a model of faulty verification patterns. Alternatively, the Entity 2 and/or the Merchant 6 may receive information pertaining to incomplete or faulty actions.

While an unauthorized Entity may obtain other Entity's PINs/KEYs, and could even conceivably possess access to appropriate Transaction PINs/KEYs (through monitoring communications, this would still not permit the entry of fraudulent transactions, as the transactions may require a new PIN/KEY for each transaction. It may be added that PIN/KEY may be configured and grouped by the level and the amount of the transaction and changed for any future Actions.

It may be noted that the Central Authentication Enterprise 5 can store each of the transmissions between the Merchant 6, the Entity 2 and other authorizing organizations 8 to provide the system with a complete transaction verification history, analysis and auditing facilities. The system will scale well using a variety of computer technologies, and is capable of providing complete security against intrusion from unauthorized on-line attack, through the use of conventional electronic firewall technologies as are well understood in the art.

Other Verifications and Validation

At any time between the Verification Request 22 and the Verification Response 23, the Central Authentication Enterprise 5 may perform other tests on the validity of the transaction. These tests include, but are not limited to:
ensuring that the transaction PIN/KEY is valid.
ensuring that the virtual accounts referred to are valid and usable for the transaction.
ensuring that the conditions attached to the real accounts used are honored, e.g. funds are available.

The Central Authentication Enterprise 5 may decline to process Verification or may refuse to verify transactions based on the results of such tests. In the preferred embodiment, any other validation such as suggested above will occur at this time, as complete information about the transaction including the validity of the transaction will be known to the merchant 6. At this time other authorizing agencies 8 may be contacted via link 32 to provide the system with complete verification. Other activities triggered by a valid transaction could also be performed at this time, for example a transfer of funds from a merchant to an Entity's account.

### EXAMPLES OF OTHER EMBODIMENTS

Using Wireless Communications Device (terminal links 15)

Shown in FIG. 1 is a Multi Account Security Verification System for executing verifications of transaction. Each merchant 6 posses an input device 18, used as a data entry device. Each Entity 2 posses a smart card 1 with Wireless communication capabilities whereas the virtual account number assigned to this card (referred in this example as the “device”). The device may be constructed as a smart card/PDA with communications devices components (terminal links 15). In this embodiment the device stores the virtual account number and other data in its storage means (memory). A merchant 6 data input system is operative to receive account data stored in an entity's hand-held device. Data representative of the entity's bio and the entity's virtual account information and selected PINs can be transmitted from the entity's device to the merchant's data input means. Wireless communication can be used to transmit/receive data between the entity's hand-held device and the merchant data input means. For example, data may be transmitted/received via a communications device (e.g., modem, infrared transmitter, RFID, blue tooth device, or similar technology). In an exemplary embodiment the range of communication between the entity's hand-held device and the merchant data input system can be limited to a specific distance, such as a few inches to a few feet. The use of a limited wireless communication range can avoid interference and permit communication only with the other device. The communication may also be encrypted to ensure confidentiality of data. The merchant 6 then submits a verification request to the CAE 5. The CAE process the verification request 22 and returns a verification response 23. The verification response 23 is to be used by the merchant 6 in order to complete the transaction or cancel it. The CAE 5 may submit an authorization request to the Financial Enterprise/Clearing Agent 8 in order to further authenticate and authorize the transaction originated by the entity and which the real account was retrieved from the CAE database 7. In a particular example, the Financial Enterprise/Clearing Agent 8 will validate the real account and designate the source of the funds and then it will submit a response to the CAE if funds are available and if the account is valid and authenticated.

Using Merchant's Data Input Device 18

Shown in FIG. 1 is a Multi Account Security Verification System for executing verifications of transaction. Each merchant 6 posses an optional input device 18, used as a data entry device. Each Entity 2 posses a card 1 with a virtual account number printed or embedded in the card. The card may be constructed as any other conventional plastic card with a magnetic strip or a bar code. The magnetic strip or the bar code contains the virtual account number assigned to the card. When an entity 2 needs to perform a transaction, he submits his card 1 to the merchant 6. The merchant 6 then types-in the input devices 18, control digits as submitted by the Entity 2 as required to retrieve account data. In alternative to this example, the entity 2 types directly in the input devices 18, the PIN or control digits required to retrieve account data (In this example, because the PIN is not revealed to the merchant, it may be used several times for similar transactions). The merchant 6 then submits a verification request to the CAE 5. The CAE process the verification request 22 and returns a verification response 23. The verification response 23 is to be used by the merchant 6 in order to complete the transaction or cancel it. The CAE 5 may submit an authorization request to the Financial Enterprise/Clearing Agent 8 in order to further authenticate and authorize the transaction originated by the entity and which the real account was retrieved from the CAE database 7.

Using Smart Card and Account/PIN Selector 25

Shown in FIG. 1 is a Multi Account Security Verification System for executing verifications of transaction. Each merchant 6 posses an optional input device 18, used as a data entry device. Each Entity 2 posses a card 1 constructed as a smart card/RFID card. In this embodiment the card stores the virtual account number and other data in its storage means (memory). When an entity 2 needs to perform a transaction, he selects a PIN number/Account serial using the Account/PIN selector 25 and then submits his card 1 to the merchant 6. The merchant 6 then reads the card data using the input devices 18. The card's readable data include virtual account number and selected PIN/Account serial. The merchant 6 then submits the data read from the card in a verification request to the CAE 5. The CAE process the verification request 22 and returns a verification response 23. The verification response 23 is to be used by the merchant 6 in order to complete the transaction or cancel it. The CAE 5 may submit an authorization request to the Financial Enterprise/Clearing Agent 8 in order to further authenticate and authorize the transaction originated by the entity and which the real account was retrieved from the CAE database 7. In a particular example, the Financial Enterprise/Clearing Agent 8 will validate the real account and designate the source of the funds and then it will submit a response to the CAE if funds are available and if the account is valid and authenticated. In a different option of this embodiment PINs/KEYs list 12 may be sent electronically by the CAE to the entity's card to be stored in his card's memory for future transactions.

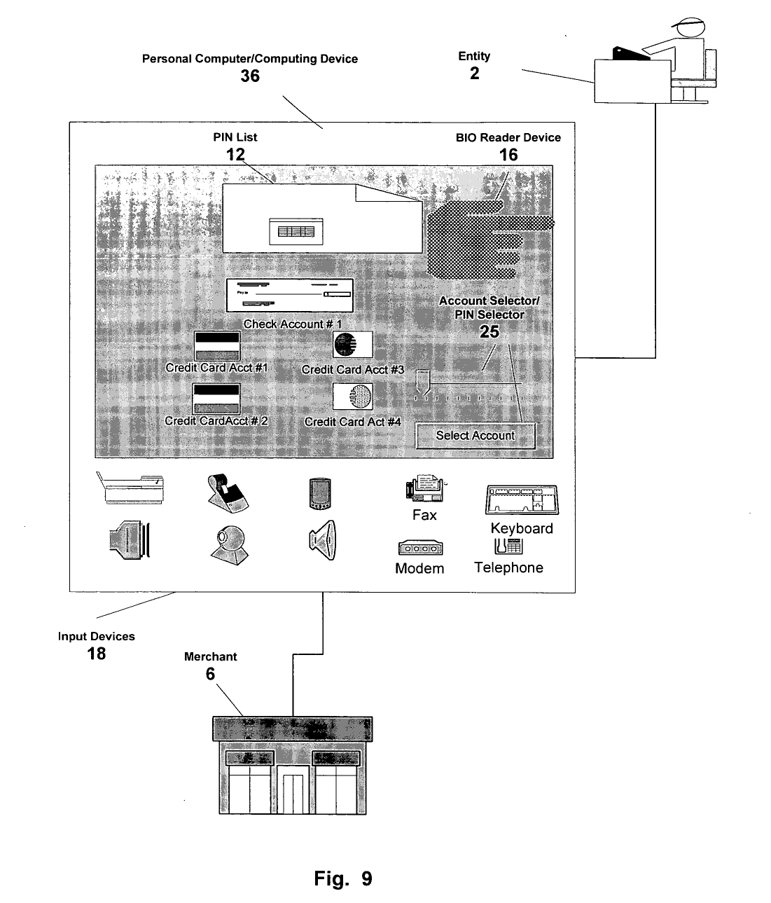

Using Entity's Computer—FIG. 9

In one other embodiment (Referring to FIG. 9), the Entity's computer 36 may be programmed such that the Entity can directly request to initiate a transaction with the merchant 6 using communication link 32. The Entity enters details of the transaction and then inputs a transaction PIN/KEY from PIN list 12 into his computer. All the verification processes are processed on-line using communication link 32. In this embodiment the verification request 22 will be sent to the CAE 5, after the Entity 2 had initiated the transaction with the merchant 6. The Entity 2 may also access the CAE 5 simultaneously and update his data on-line. In this embodiment the merchant 6 will receive from the CAE the required authorizations in the form of verification response 23 in addition to needed transaction data required to proceed with the transaction. In a different option of this embodiment PINs/KEYs list 12 may be sent electronically by the CAE to the entity's computer to be stored in his computer for future transactions. The Entity's computer 36 may include BIO identification devices for which verification details will be sent to the CAE in the verification request as described in the next embodiment.

Using Smart Card with BIO Devices

Shown in FIG. 1 is a Multi Account Security Verification System for executing verifications of transaction. Each merchant 6 posses an optional input device 18, used as a data entry device. Each Entity 2 posses a card 1 constructed as a smart card. In this embodiment the entity may use other processes and criteria to gain access to the card data and the data includes virtual account number and other data in its storage means (memory). This embodiment (FIG. 6) of the invention includes a bio reader device 16. The bio reader device may include hardware and software components that can be used to sense a characteristic of a user, which uniquely identifies the person as an authorized user. In some embodiments the biometric reader device 16 may include a fingerprint reading device. Alternatively, the reader may include an audio input device, which can be used to identify a user by voice. Alternatively, visual readers for identifying unique visible features or a combination of identifying features of the user may be used. The memory of the card may include data representative of the identifying biometric features of the authorized user or users. This stored data is used to enable authorized users of the card to operate the card while others are prevented from such operation. In addition, terminal means 15 can be used to send bio data to the Central Authentication Enterprise for further authentication. Once the user has properly gained access he may be given the option of changing PIN list stored in its memory or other data transaction. When an entity 2 needs to perform a transaction, he selects a PIN/Account Serial. The merchant 6 then reads the card data using the input devices 18. The card's readable data include virtual account number and selected PIN/Account serial. The merchant 6 then submits the data read from the card in a verification request to the CAE 5. The CAE process the verification request 22 and returns a verification response 23. The verification response 23 is to be used by the merchant 6 in order to complete the transaction or cancel it. The CAE 5 may submit an authorization request to the Financial Enterprise/Clearing Agent 8 in order to further authenticate and authorize the transaction originated by the entity and which the real account was retrieved from the CAE database 7. In a particular example, the Financial Enterprise/Clearing Agent 8 will validate the real account and designate the source of the funds and then it will submit a response to the CAE if funds are available and if the account is valid and authenticated. In a different option of this embodiment PINs/KEYs list 12 may be sent electronically by the CAE to the entity's card to be stored in his card's memory for future transactions.

Using Smart Card with Display 14

Shown in FIG. 1 is a Multi Account Security Verification System for executing verifications of transaction. Each merchant 6 posses an optional input device 18, used as a data entry device. Each Entity 2 posses a card 1 constructed as a smart card/RFID card. As shown in FIG. 6 in the embodiment shown, the card may further include an input device that includes a manual input device for selecting Account/PIN. The Account/PIN selector 25 can be used for entry or selection of the user's PIN or Control Digits stored as PINS/KEYs list 12 (FIG. 5). The card also includes an electronic display screen 14 on the front face thereof. In this embodiment of the invention electronic display screen 14 is an LCD type display or other suitable display that may be used for displaying words, graphics and other visible indicia in a manner later explained. When pressing the button or slider 25, the electronic display screen 14 begins a scrolling through the listed accounts in memory. The card then will display the required PIN in the display screen 14 used to select the corresponding account and further can be used for authentication. The card may include only buttons to scroll up/down (button or slider 25). These scroll up and scroll down buttons, are pressed by a user to selectively display items on the display. The card can be used to transmit the required PIN and virtual account to the Central Authentication Enterprise 5 using terminal means 15. The card's memory may further include data representative of visual indicia, which are found on a plurality of cards or other objects associated with the virtual account. The visible indicia may include for example, bar code indicia representative of a user's real account. Alternatively such visible indicia may include bar code, alpha numeric accounts or other indicia associated with a membership I.D., Credit Cards, Checking Accounts, student I.D., employee access card, driver's license, or other types of objects. The visible indicia displayed using display screen 14 may also include a Central Authentication Enterprise 5 responses, real account data, or other data. The terminal means 15 may include options upon which the stored visible indicia may be reproduced in response to inputs to the terminal means. This enables visible indicia displayed in display screen 14 to be read, which serves as a substitute for scanning off the card. The card memory may also include data representative of icons or other graphics as well as data representative of real accounts stored in the CAE 5

Merchant Residing with CAE

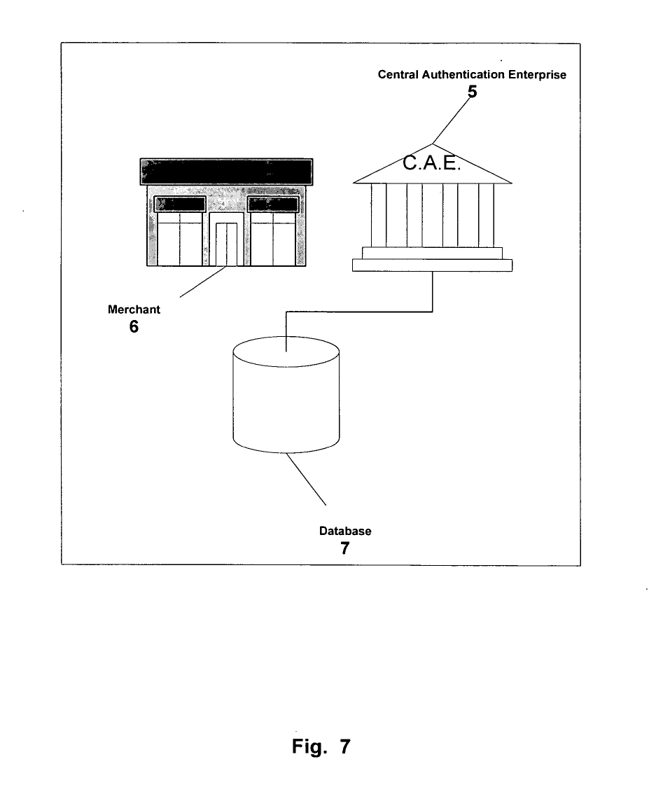

In one other embodiment (Referring to FIG. 7), the Merchant 6 may reside with the CAE 5 and programmed such that, Entities will be able to pick their PINs/KEYs list 12 as described before, and then input the PINs/KEYs by means described before. In this embodiment, the Merchant 6 and the CAE 5 may be the same organization and may share same computer hardware and software means. The method of verification can be done as described in the preferred embodiment.

CAE Residing with Financial Enterprise/Clearing Agent

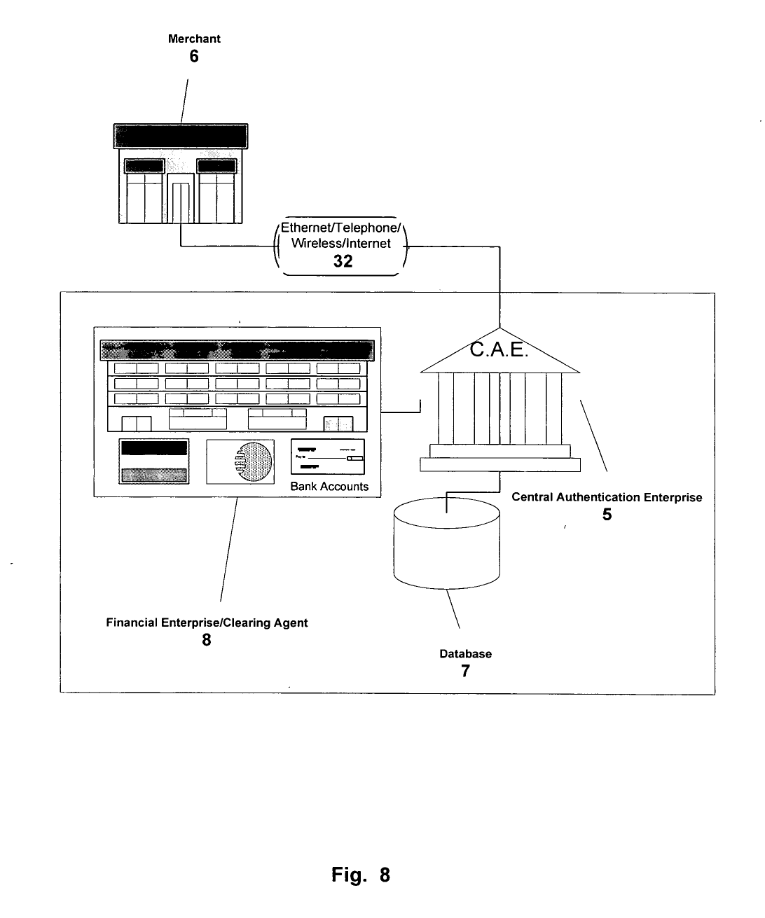

In one other embodiment (Referring to FIG. 8), the CAE 5 may reside with the Financial Enterprise/Clearing Agent 8 and programmed such that, Entities will be able to pick their PINs/KEYs list 12 as described before, and then input the PINs/KEYs by means described before. In this embodiment, the CAE 5 and the Financial Enterprise/Clearing Agent 8 may be the same organization (e.g. a bank and its check verification department, or a credit card company). The method of verification can be done as described in the preferred embodiment.

While only one cycle of each process or method disclosed herein has been described in detail, it should be understood that the processes or methods disclosed herein are designed to be repeated for any one of a number of predetermined times so that transaction security verifications can be executed between any one of the Merchants and any one of the Central authentication Enterprises.

In the above embodiments, it should be noted that communication between the Entities, Central Authentication Enterprise and Merchants involved in a particular verification or transaction may be triggered automatically, for example, by means of a sequential logic process, or through a time schedule system, or alternatively may require a manual intervention to trigger the next phase of an action.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

The invention claimed is:

1. A multi account security verification system for authorization and authentication comprising:
a Card having generally about the same dimensions as a standard credit card, said card having account storage means, said account storage means including, (a) magnetic strip, (b) smart card, (c) RFID card, (d) bar code, (e) electronic memory, (f) computer, wherein said account storage means are used to store virtual account numbers,
a Database with multiple real account numbers linked to said virtual account number,
a Data Input means used for data input, wherein said data input including:, (a) PINS, (b) BIO data, wherein said data input entered into the said Data Input means selects the corresponding said real account stored in the said database, wherein said PINS including:, (a) alpha numeric digits, (b) public keys, (c) private keys,
a Central Authentication Enterprise wherein said security verification is performed, via a computer network, based on said virtual account number stored on said account storage means wherein said real account numbers are retrieved from said database using said virtual account number and said data input entered into said Data Input means, wherein said data input could further be used for verification.

2. The security verification system of claim 1, wherein said database includes a plurality of said PINs, linked to said real account numbers, said PINs, including, (a) secret key sets, (b) public/private key sets, (c) one time key sets.

3. The security verification system of claim 1, wherein said database includes BIO information linked to said virtual account number used for said security verification, said BIO information including, (a) fingerprint data, (b) retina data, (c) voice data, (d) physical appearance data.

4. The security verification system of claim 1, wherein said card includes memory, wherein the memory is operative to store data associated with at least one account, wherein said memory can be used to store said PIN sets associated with each said account, wherein the said card optionally includes at least one display device, wherein the at least one display device is operative to electronically display data corresponding to an account associated with the data.

5. The security verification system of claim 1, wherein said Central Authentication Enterprise uses said communicated virtual account and said data input to access and retrieve stored referenced said PINs from said database by using comparing means for comparing said data input to a collection of said PINs belonging to the referenced communicated virtual account, thereby verifying a transaction when a data input and referenced virtual account match to stored PIN.

6. The security verification system of claim 1, wherein said card further comprises terminal interface means for communicating and receiving data from outside peripherals and store the said received data in the said card internal memory.

7. The security verification system of claim 1, wherein the said card includes memory and a writeable magnetic strip, wherein the magnetic strip is adapted to store magnetic strip data associated with the account.

8. The security verification system of claim 1, wherein real account names are listed on the face of the said card.

9. The security verification system of claim 1, wherein real account number can be selected by using input means built into the said card, wherein input means including:, (a) electronic buttons, (b) computer input, (c) mechanical input.

10. A multi account card system comprising:
a virtual account number assigned to an entity
a database with multiple real account numbers linked to said virtual account number,
a Central Authentication Enterprise wherein security verification is performed based on said virtual account number assigned to said entity, wherein said real account numbers are retrieved from said database using said virtual account number and data input, wherein said data input is communicated by electronic means.

11. The security verification system of claim 10, including Data Input means used for said data input, wherein said data input including:, (a) PINS, (b) BIO data, wherein said data input entered into the said Data Input means selects the corresponding said real account stored in the said database, wherein said PINS including:, (a) alpha numeric digits, (b) public keys, (c) private keys.

12. The security verification system of claim 10, wherein said database includes a plurality of PINs, linked to said real account numbers, said PINs, including, (a) secret key sets, (b) public/private key sets, (c) one time key sets.

13. The security verification system of claim 10, wherein said database includes BIO information linked to said virtual account number used for said security verification, said BIO information including, (a) fingerprint data, (b) retina data, (c) voice data, (d) physical appearance data.

14. The security verification system of claim 10, which includes a Card having generally about the same dimensions as a standard credit card, said card having account storage means, said account storage means including, (a) magnetic strip, (b) smart card, (c) RFID card, (d) bar code, (e) electronic memory, (f) computer, wherein said account storage means are used to store virtual account numbers.

15. The security verification system of claim 10, which includes a Card having generally about the same dimensions as a standard credit card, said card having account storage means, wherein said account storage means are used to store virtual account numbers and optionally data associated with the accounts, wherein said storage means can be used to store PIN sets associated with each said account, wherein the said card optionally includes at least one display device, wherein the at least one display device is operative to electronically display data corresponding to an account associated with the data.

16. The security verification system of claim 10, which includes a Card having generally about the same dimensions as a standard credit card, said card having account storage means, wherein said account storage means are used to store virtual account numbers and optionally data associated with the accounts, wherein said card further comprises terminal interface means for communicating and receiving data from outside peripherals and store the said received data in the said card internal memory.

17. The security verification system of claim 10, wherein said Central Authentication Enterprise uses said communicated virtual account and said data input to access and retrieve stored referenced data from said database by using comparing means for comparing said data input to a collection of stored data belonging to the referenced communicated virtual account, thereby verifying a transaction when a data input and referenced virtual account match to stored data.

18. The security verification system of claim 10, which includes a Card having generally about the same dimensions as a standard credit card, said card having account storage means, said account storage means including, (a) magnetic strip, (b) smart card, (c) RFID card, (d) bar code, (e) electronic memory, (f) computer, wherein said account storage means are used to store virtual account numbers, wherein real account number can be selected by using input means, wherein input means including:, (a) electronic buttons, (b) computer input, (c) mechanical input.
